(19) United States
(12) Patent Application Publication
(10) Pub. No.: US 2026/0058057 A1
(43) Pub. Date: Feb. 26, 2026

(54) CAPACITOR AND METHOD FOR MANUFACTURING CAPACITOR

(71) Applicant: Panasonic Intellectual Property Management Co., Ltd., Osaka (JP)

(72) Inventors: HIROKI TAKEOKA, Nara (JP); HIROSHI FUJII, Osaka (JP)

(21) Appl. No.: 19/306,872

(22) Filed: Aug. 21, 2025

Related U.S. Application Data
(63) Continuation of application No. PCT/JP2024/005120, filed on Feb. 14, 2024.

(30) Foreign Application Priority Data
Mar. 14, 2023 (JP) 2023-039295

(51) Int. Cl. H01G 2/10; H01G 13/00

(52) U.S. Cl. CPC H01G 2/103; H01G 13/003

(57) ABSTRACT

A capacitor includes a capacitor element, a bus bar, and an exterior body. The bus bar includes a connection terminal portion, a first extension portion, and a second extension portion. The connection terminal portion includes a connection surface exposed from the exterior body. An opposite surface of the connection terminal portion that is opposed to the connection surface is positioned apart from one surface of the exterior body, the opposite surface facing the one surface. Each of the first extension portion and the second extension portion extends from corresponding one of both ends in a first direction of the connection terminal portion, a part of the each of the first extension portion and the second extension portion extending in a direction intersecting with the connection surface and being embedded in the exterior body. The first extension portion is connected to the electrode inside the exterior body.

### TECHNICAL FIELD

The present disclosure relates to a capacitor such as a film capacitor. The present disclosure further relates to a method for manufacturing a capacitor.

### BACKGROUND

Conventionally, there has been known a capacitor in which one or a plurality of capacitor elements are covered with an exterior body made of a thermosetting resin such as an epoxy resin. As a capacitor like this, there are so-called case molded capacitors and so-called caseless capacitors.

A case molded capacitor includes a case that houses a capacitor element, and an exterior body is formed in the case by filling the case with a thermosetting resin and curing the thermosetting resin. In a caseless capacitor, for example, a capacitor element is housed in a casting mold, and the casting mold is filled with a thermosetting resin. After the thermosetting resin cures to form an exterior body, the capacitor is taken out from the casting mold.

As an example of such capacitors, Unexamined Japanese Patent Publication No. 2006-294788 describes a case molded capacitor in which a capacitor element having lead terminals, which are bus bars, connected to both end surfaces, is housed in a case, and the case is filled with a molding resin. The capacitor element is covered with a molding resin, and one end portion of each lead terminal is exposed from the molding resin as a terminal portion for external connection.

### SUMMARY

A first aspect of the present disclosure relates to a capacitor. A capacitor according to the present aspect includes a capacitor element including an electrode, a bus bar connected to the electrode, and an exterior body covering the capacitor element and a part of the bus bar, the exterior body being made of a resin. Here, the bus bar includes a connection terminal portion, a first extension portion, and a second extension portion. The connection terminal portion includes a connection surface exposed from the exterior body. An opposite surface of the connection terminal portion that is opposed to the connection surface is positioned apart from one surface of the exterior body, the opposite surface facing the one surface. Each of the first extension portion and the second extension portion extends from corresponding one of both ends in a first direction of the connection terminal portion, a part of the each of the first extension portion and the second extension portion extending in a direction intersecting with the connection surface and being embedded in the exterior body. The first extension portion is connected to the electrode inside the exterior body.

A second aspect of the present disclosure relates to a capacitor. A capacitor according to the present aspect includes a capacitor element including an electrode on each of both end surfaces of the capacitor element, a bus bar connected to the electrode, and an exterior body covering the capacitor element and a part of the bus bar, the exterior body being made of a resin. Here, the bus bar includes a connection terminal portion, a first extension portion, and a second extension portion. The connection terminal portion includes a connection surface having a flat shape, the connection terminal portion being exposed from the exterior body. An opposite surface of the connection terminal portion that is opposed to the connection surface is positioned apart from one surface of the exterior body, the opposite surface facing the one surface. The first extension portion extends from an end in a first direction of the connection terminal portion, a part of the first extension portion extending in a direction intersecting with the connection surface and being embedded in the exterior body. The second extension portion extends from each of both ends in a second direction orthogonal to the first direction of the connection terminal portion, a part of the second extension portion extending in the direction intersecting with the connection surface and being embedded in the exterior body. The first extension portion is connected to the electrode inside the exterior body.

A third aspect of the present disclosure relates to a method for manufacturing a capacitor. A method according to the present aspect includes an installation step of installing a capacitor module in a casting mold including an opening, the capacitor module including a capacitor element including an electrode on each of both end surfaces of the capacitor element and a bus bar connected to the electrode, an injection step of injecting a thermosetting resin in a liquid phase from the opening into the casting mold in which the capacitor module is installed, and a curing step of heating and curing the thermosetting resin filled in the casting mold to form an exterior body covering the capacitor element and a part of the bus bar. Here, the bus bar includes a connection terminal portion, a first extension portion, and a second extension portion. The connection terminal portion includes a connection surface having a flat shape to which an external terminal is connected. Each of the first extension portion and the second extension portion extends from corresponding one of both ends in a first direction of the connection terminal portion, the each of the first extension portion and the second extension portion extending in a direction intersecting with the connection surface toward the capacitor element. The first extension portion is connected to the electrode. In the installation step, the capacitor module is installed in the casting mold in a state that the connection terminal portion is disposed close to the opening. In the injection step, the thermosetting resin is injected into the casting mold so that a liquid level of the thermosetting resin to be a casting surface of the exterior body faces an opposite surface of the connection terminal portion that is opposed to the connection surface with being apart from the opposite surface, and a distal end of the first extension portion and a distal end of the second extension portion are embedded in the thermosetting resin.

A fourth aspect of the present disclosure relates to a method for manufacturing a capacitor. A method according to the present aspect includes an installation step of installing a capacitor module in a casting mold including an opening, the capacitor module including a capacitor element including an electrode on each of both end surfaces of the capacitor element and a bus bar connected to the electrode, an injection step of injecting a thermosetting resin in a liquid phase from the opening into the casting mold in which the capacitor module is installed, and a curing step of heating and curing the thermosetting resin filled in the casting mold to form an exterior body covering the capacitor element and a part of the bus bar. Here, the bus bar includes a connection terminal portion, a first extension portion, and a second extension portion. The connection terminal portion includes a connection surface having a flat shape to which an external terminal is connected. The first extension portion extends from an end in a first direction of the connection terminal portion toward the capacitor element in a direction intersecting with the connection surface, the first extension portion being connected to the electrode. The second extension portion extends from each of both ends in a second direction orthogonal to the first direction of the connection terminal portion toward the capacitor element in a direction intersecting with the connection surface. In the installation step, the capacitor module is installed in the casting mold in a state that the connection terminal portion is disposed close to the opening. In the injection step, the thermosetting resin is injected into the casting mold so that a liquid level of the thermosetting resin to be a casting surface of the exterior body faces an opposite surface of the connection terminal portion that is opposed to the connection surface with being apart from the opposite surface, and a distal end of the first extension portion and a distal end of the second extension portion are embedded in the thermosetting resin.

The present disclosure can provide a capacitor with which connection work between a connection terminal portion of a bus bar exposed from an exterior body and an external terminal can be smoothly performed and a method for manufacturing a capacitor capable of manufacturing such a capacitor.

Effects or meanings of the present disclosure will be further clarified in the following description of exemplary embodiments. The exemplary embodiments described below are merely examples for implementing the present disclosure, and the present disclosure is not limited to those described in the following exemplary embodiments at all.

### BRIEF DESCRIPTION OF THE DRAWINGS

FIG. 1A is a perspective view illustrating a capacitor according to a first exemplary embodiment.

FIG. 1B is a sectional view illustrating a capacitor cut in parallel with a Y-Z plane at the positions of a pair of bus bars according to the first exemplary embodiment.

FIG. 2A is a perspective view illustrating a capacitor module according to the first exemplary embodiment.

FIG. 2B is a perspective view illustrating a pair of bus bars according to the first exemplary embodiment.

FIG. 3A is a diagram for describing a step of forming an exterior body according to the first exemplary embodiment.

FIG. 3B is a diagram for describing a step of forming the exterior body according to the first exemplary embodiment.

FIG. 3C is a diagram for describing a step of forming the exterior body according to the first exemplary embodiment.

FIG. 4A is a sectional view illustrating a capacitor cut in parallel with a Y-Z plane at the positions of a pair of bus bars according to a first modification of the first exemplary embodiment.

FIG. 4B is a perspective view illustrating a bus bar according to the first modification of the first exemplary embodiment.

FIG. 5A is a sectional view illustrating a capacitor cut in parallel with a Y-Z plane at the positions of a pair of bus bars according to a second modification of the first exemplary embodiment.

FIG. 5B is a perspective view illustrating a bus bar according to the second modification of the first exemplary embodiment.

FIG. 6A is a sectional view illustrating a capacitor cut in parallel with a Y-Z plane at the positions of a pair of bus bars according to a third modification of the first exemplary embodiment.

FIG. 6B is a perspective view illustrating a bus bar according to the third modification of the first exemplary embodiment.

FIG. 7A is a sectional view illustrating a capacitor cut in parallel with a X-Z plane at the positions of a pair of bus bars according to a fourth modification of the first exemplary embodiment.

FIG. 7B is a diagram of a bus bar according to the fourth modification of the first exemplary embodiment as viewed in a Y-axis positive direction.

FIG. 8A is a perspective view illustrating a capacitor according to a fifth modification of the first exemplary embodiment.

FIG. 8B is a perspective view illustrating a capacitor module according to the fifth modification of the first exemplary embodiment.

FIG. 9A is a plan view illustrating a state in which a capacitor is fixed to an external device using a fixing member according to the fifth modification of the first exemplary embodiment.

FIG. 9B is a sectional view taken along line A-A′ of FIG. 9A.

FIG. 10A is a diagram for describing a pair of bus bars according to another modification of the first exemplary embodiment.

FIG. 10B is a diagram for describing a pair of bus bars according to another modification of the first exemplary embodiment.

FIG. 10C is a diagram for describing a pair of bus bars according to another modification of the first exemplary embodiment.

FIG. 10D is a diagram for describing a pair of bus bars according to another modification of the first exemplary embodiment.

FIG. 11A is a diagram of a capacitor according to a second exemplary embodiment as viewed in a Z-axis negative direction.

FIG. 11B is a diagram of the capacitor according to a second exemplary embodiment as viewed in an X-axis negative direction.

FIG. 12A is a sectional view taken along line B-B′ of FIG. 11A according to the second exemplary embodiment.

FIG. 12B is a sectional view taken along line C-C′ of FIG. 11A according to the second exemplary embodiment.

FIG. 13 is an exploded perspective view illustrating a capacitor module according to the second exemplary embodiment.

FIG. 14A is a diagram of a bus bar according to a first modification of the second exemplary embodiment as viewed in the Y-axis positive direction.

FIG. 14B is a diagram of a bus bar according to a second modification of the second exemplary embodiment as viewed in the Y-axis positive direction.

FIG. 15A is a diagram of a capacitor according to a third modification of the second exemplary embodiment as viewed in the Z-axis negative direction.

FIG. 15B is a diagram of the capacitor according to the second exemplary embodiment as viewed in the X-axis negative direction, in which a fixing member is installed.

### DESCRIPTION OF EMBODIMENT

Prior to the description of the exemplary embodiment, a brief description of the problems in the conventional technology will be described.

In the case of molded capacitor of Unexamined Japanese Patent Publication No. 2006-294788, a terminal portion for external connection extends straight outward from one surface of a molding resin, and an external terminal included in an inverter circuit or the like is connected to one of the two surfaces of the terminal portion along an extending direction by a connection method such as welding.

At the time of connection work, it is necessary to press the external terminal against one surface of the terminal portion to firmly adhere the external terminal to the surface. Thus, it is necessary to support the other surface side of the terminal portion with some kind of jig. Thus, in the configuration of the case molded capacitor described above, there is a concern that the connection work by welding or the like tends to take time and effort.

The present disclosure provides a capacitor with which connection work between a connection terminal portion of a bus bar exposed from an exterior body and an external terminal can be smoothly performed and a method for manufacturing a capacitor capable of manufacturing such a capacitor.

Hereinafter, exemplary embodiments of the present disclosure will be described with reference to the drawings. For the sake of convenience, an X-axis, a Y-axis, and a Z-axis perpendicular to each other are added to the drawings. The Y-axis is perpendicular to a pair of end surfaces 101 of capacitor element 100.

### First Exemplary Embodiment

A first exemplary embodiment is an exemplary embodiment of a capacitor according to the first aspect of the present disclosure and a method for manufacturing a capacitor according to the third aspect of the present disclosure.

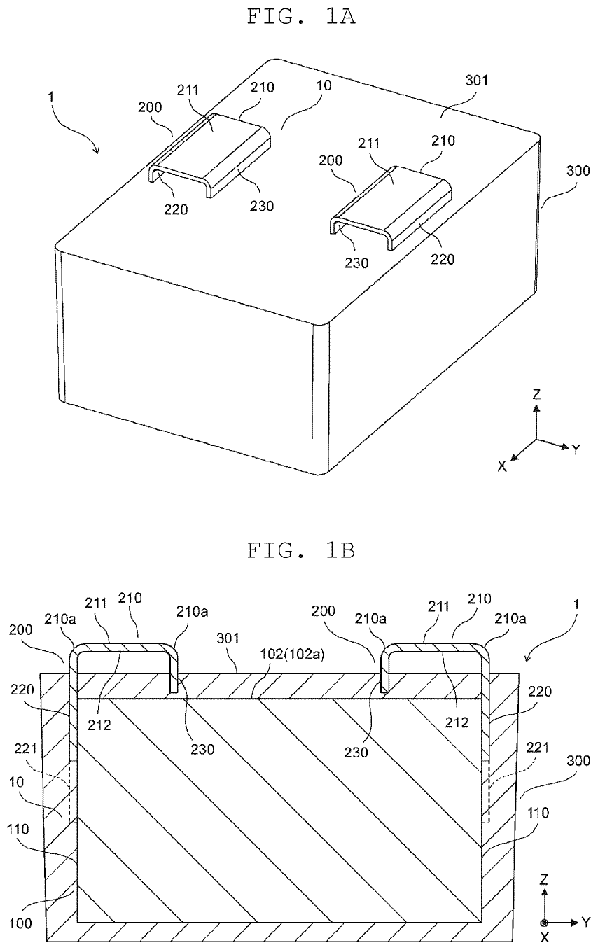

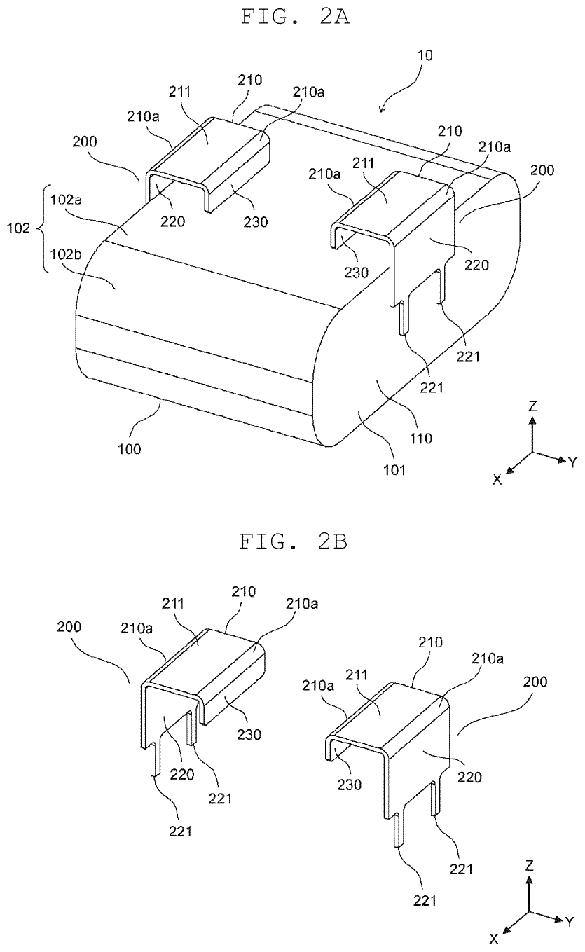

FIG. 1A is a perspective view illustrating capacitor 1 according to the first exemplary embodiment. FIG. 1B is a sectional view illustrating capacitor 1 cut in parallel with a Y-Z plane at the positions of a pair of bus bars 200 according to the first exemplary embodiment. FIG. 2A is a perspective view illustrating capacitor module 10 according to the first exemplary embodiment, and FIG. 2B is a perspective view illustrating the pair of bus bars 200 according to the first exemplary embodiment.

Capacitor 1 is a so-called caseless capacitor, including capacitor element 100, the pair of bus bars 200, and exterior body 300. The pair of bus bars 200 is connected to capacitor element 100 to constitute capacitor module 10.

Capacitor element 100 is a film capacitor element. The capacitor element is formed into a shape similar to a flattened oblong cylinder by stacking two metalized films each having vapor-deposited aluminum on a dielectric film, winding or laminating the stacked metallized films, and pressing the stacked metalized films. Capacitor element 100 has a pair of end surfaces 101 and peripheral surface 102. Peripheral surface 102 includes a pair of flat surfaces 102a arranged in a Z-axis direction and a pair of curved surfaces 102b arranged in an X-axis direction. Electrodes 110 are formed on both end surfaces 101 of capacitor element 100 by spraying metal such as zinc.

Capacitor element 100 may be formed of a metalized film on which another metal such as zinc or magnesium is vapor-deposited in addition to the formation of a metalized film on which aluminum is vapor-deposited on a dielectric film. Alternatively, capacitor element 100 may be formed of a metalized film having a plurality of metals among these metals vapor-deposited, or may be formed of a metalized film having an alloy of these metals vapor-deposited.

The pair of bus bars 200 are formed of a conductive material, for example, copper. Each bus bar 200 includes connection terminal portion 210, first extension portion 220, and second extension portion 230.

Connection terminal portion 210 is formed in a rectangular plate shape and has flat connection surface 211 to which external terminal 4 is connected. Connection surface 211 faces a Z-axis positive direction.

Each of first extension portion 220 and second extension portion 230 is formed in a rectangular plate shape, and extends in the Z-axis negative direction perpendicular to connection surface 211 from corresponding one of both ends 210a in a Y-axis direction of connection terminal portion 210. The Y-axis direction is a first direction. In the present exemplary embodiment, the first direction is perpendicular to end surface 101 of capacitor element 100.

First extension portion 220 has a longer size in the Z-axis direction than second extension portion 230. A pair of electrode terminals 221 having a pin shape and arranged in the X-axis direction is formed at a distal end (end in the Z-axis negative direction) of first extension portion 220.

The pair of bus bars 200 is disposed side by side in the Y-axis direction. Connection terminal portions 210 of the pair of bus bars 200 are positioned at positive direction side in the Z-axis with respect to capacitor element 100. In the direction (Z-axis direction) in which capacitor element 100 and connection terminal portion 210 are aligned, positions of connection surfaces 211 of connection terminal portion 210 of bus bars 200 are equal to each other.

Bus bar 200 positioned at positive direction side in the Y-axis with respect to capacitor element 100 is assembled to capacitor element 100 in a state that first extension portion 220 is at positive direction side in the Y-axis and second extension portion 230 is at negative direction side in the Y-axis with respect to connection terminal portion 210. A distal end portion of first extension portion 220 of bus bar 200 overlaps electrode 110 at positive direction side in the Y-axis of capacitor element 100, and the pair of electrode terminals 221 is joined to electrode 110 by a joining method such as soldering. This connects bus bar 200 electrically to capacitor element 100.

Similarly, bus bar 200 positioned at negative direction side in the Y-axis with respect to capacitor element 100 is assembled to capacitor element 100 in a state that first extension portion 220 is at negative direction side in the Y-axis and second extension portion 230 is at positive direction side in the Y-axis with respect to connection terminal portion 210. A distal end portion of first extension portion 220 of bus bar 200 overlaps electrode 110 at negative direction side in the Y-axis of capacitor element 100, and the pair of electrode terminals 221 is joined to electrode 110 by a joining method such as soldering. This connects bus bar 200 electrically to capacitor element 100.

In the pair of bus bars 200, connection terminal portions 210 overlap peripheral surface 102 (flat surface 102a) of capacitor element 100 as viewed in the Z-axis direction. A distal end (end at negative direction in the Z-axis) of second extension portion 230 is separated from peripheral surface 102 (flat surface 102a) of capacitor element 100.

Exterior body 300 is formed of thermosetting resin 3 such as an epoxy resin, has a substantially rectangular parallelepiped shape (hexahedron shape) long in the X-axis direction, and has six surfaces whose outer surfaces are rectangular. Exterior body 300 covers capacitor module 10, that is, whole capacitor element 100 and a part of the pair of bus bars 200. Exterior body 300 protects capacitor element 100 from intrusion of moisture and impact.

As described later, exterior body 300 is formed by a cast molding method using casting mold 2. Of the six surfaces of exterior body 300, the surface at positive direction side in the Z-axis (one surface of exterior body 300) is casting surface 301 obtained by curing liquid level 3a of thermosetting resin 3 injected into casting mold 2.

As illustrated in FIG. 1B, in the pair of bus bars 200, connection terminal portions 210 are exposed to the outside from casting surface 301 of exterior body 300. Connection terminal portion 210 is positioned apart from casting surface 301 of exterior body 300 such that opposite surface 212 from connection surface 211 faces casting surface 301.

A distal end portion of first extension portion 220 is embedded in exterior body 300 from casting surface 301 and is connected to electrode 110 of capacitor element 100 inside exterior body 300.

A distal end portion of second extension portion 230 is embedded in exterior body 300 from casting surface 301 and extends toward peripheral surface 102 (flat surface 102a) of capacitor element 100 facing casting surface 301 inside exterior body 300. The distal end of second extension portion 230 is not in contact with peripheral surface 102, and a portion of exterior body 300 is interposed between the distal end of second extension portion 230 and peripheral surface 102. This prevents peripheral surface 102 of capacitor element 100 from being damaged by second extension portion 230.

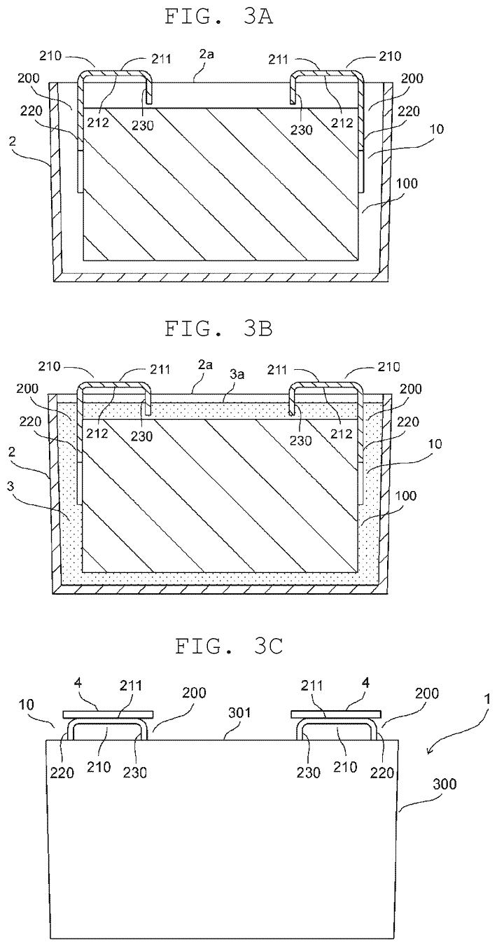

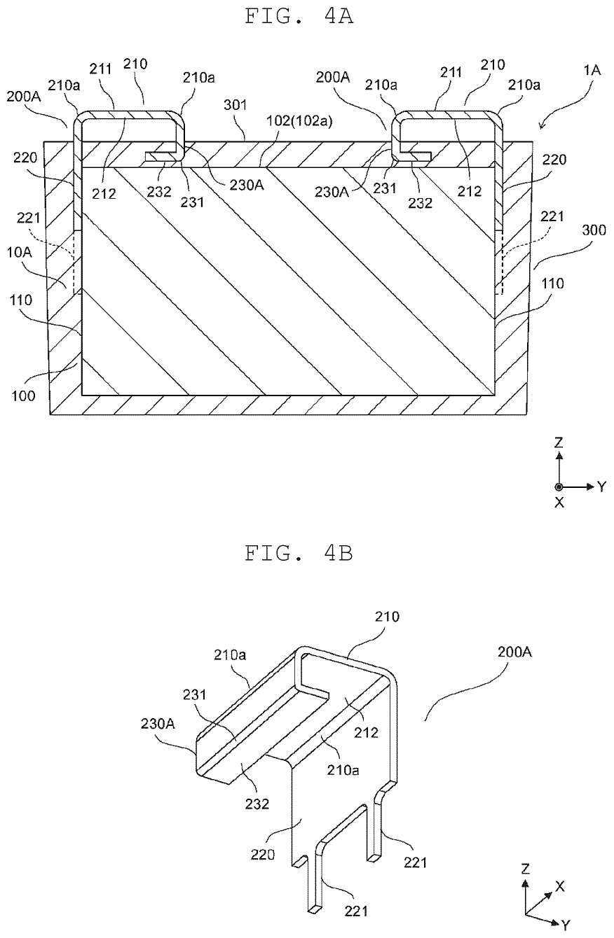

FIGS. 3A to 3C are diagrams for describing a step of forming exterior body 300 according to the first exemplary embodiment.

Exterior body 300 is formed by a cast molding method using casting mold 2. Thus, exterior body 300 can be formed more easily than an exterior body formed by a molding method using a metal mold.

Casting mold 2 is made of, for example, metal, is formed in a substantially rectangular parallelepiped box shape so as to correspond to the shape of exterior body 300, and has opening 2a on the upper surface.

In the step of forming exterior body 300, first, an installation step is performed. As illustrated in FIG. 3A, capacitor module 10 is housed in casting mold 2 through opening 2a. Capacitor module 10 is installed in casting mold 2 in a state that connection terminal portions 210 of the pair of bus bars 200 are disposed close to opening 2a. At this time, connection terminal portions 210 of the pair of bus bars 200 are fixed by a fixture (not illustrated), and capacitor element 100 is positioned with respect to casting mold 2.

Next, an injection step is performed. As illustrated in FIG. 3B, liquid-phase thermosetting resin 3, for example, an epoxy resin is injected into casting mold 2 through opening 2a. Entire capacitor element 100, and the distal end of first extension portion 220 and the distal end of second extension portion 230 of the pair of bus bars 200 are immersed in thermosetting resin 3. Liquid level 3a of thermosetting resin 3 faces opposite surface 212 of connection terminal portions 210 of the pair of bus bars 200 from connection surface 211 in a spaced apart manner. Liquid level 3a of thermosetting resin 3 becomes casting surface 301 of exterior body 300.

In this manner, connection terminal portions 210 of the pair of bus bars 200 are separated from liquid level 3a of thermosetting resin 3. Thus, unlike the case where connection terminal portion 210 is in contact with liquid level 3a of thermosetting resin 3, liquid-phase thermosetting resin 3 injected into casting mold 2 does not ride on connection surface 211 of connection terminal portion 210 because of a variation in the height of liquid level 3a due to surface tension or a manufacturing error.

Next, a curing step is performed, and casting mold 2 is heated. Thermosetting resin 3 is heated to have a high temperature. As a result, thermosetting resin 3 cures to form exterior body 300.

After exterior body 300 is formed, capacitor 1 is completed as illustrated in FIG. 3C. Capacitor 1 is taken out from casting mold 2.

When capacitor 1 is installed in an external device such as an inverter device and used, one of the pair of bus bars 200 serves as a positive electrode bus bar (P-pole bus bar) and the other serves as a negative electrode bus bar (N-pole bus bar). As illustrated in FIG. 3C, external terminals 4 of the positive electrode (P electrode) and the negative electrode (N electrode) are connected to the connection terminal portions 210 of the pair of bus bars 200 by welding such as laser welding or resistance welding. At the time of connection work, external terminal 4 can be pressed against connection surface 211 of connection terminal portion 210 so as to be firmly in close contact with connection surface 211.

In capacitor 1 of the present exemplary embodiment, both ends 210a of connection terminal portion 210 in the Y-axis direction (first direction) are supported by first extension portion 220 and second extension portion 230 which are embedded in exterior body 300. Thus, even when external terminal 4 is pressed against connection surface 211 of connection terminal portion 210, it is difficult for connection terminal portion 210 to move in the direction in which connection terminal portion 210 is pressed or in the in-plane direction perpendicular to the direction. Therefore, it is not necessary to separately hold connection terminal portion 210 with any jig, and thus, it is possible to smoothly perform the connection work by welding without taking time or effort to install the jig.

In connection terminal portion 210, opposite surface 212 from connection surface 211 is separated from one surface (casting surface 301) of exterior body 300. With this configuration, the heat generated by capacitor element 100 upon energization of capacitor 1 can satisfactorily be released from two surfaces 211 and 212 of connection terminal portion 210.

When external terminal 4 is pressed against connection terminal portion 210, a force is applied to exterior body 300 through first extension portion 220 and second extension portion 230. Thus, it is desirable that exterior body 300 has high strength. Therefore, to increase the strength, a filler may be mixed with thermosetting resin 3 constituting exterior body 300.

### <Effects of First Exemplary Embodiment>

As described above, the present exemplary embodiment has the following effects.

Capacitor 1 includes capacitor element 100 having electrodes 110 on both end surfaces 101, bus bar 200 connected to electrodes 110, and exterior body 300 formed of thermosetting resin 3 and covering capacitor element 100 and a part of bus bar 200. Bus bar 200 includes connection terminal portion 210, first extension portion 220, and second extension portion 230. Connection terminal portion 210 has flat connection surface 211 to which external terminal 4 is connected, and is exposed from exterior body 300. Opposite surface 212 of connection terminal portion 210 from connection surface 211 is positioned apart from one surface of exterior body 300 in such a manner as to face the one surface. Each of first extension portion 220 and second extension portion 230 extends in a direction (orthogonal direction) intersecting with connection surface 211 from corresponding one of both ends 210a of connection terminal portion 210 in a first direction (Y-axis direction) and is embedded in exterior body 300. First extension portion 220 is connected to electrode 110 inside exterior body 300.

According to this configuration, both ends 210a of connection terminal portion 210 in the first direction are supported by first extension portion 220 and second extension portion 230 which are embedded in exterior body 300. Thus, even when external terminal 4 is pressed against connection surface 211 of connection terminal portion 210 at the time of connection work of connecting external terminal 4 to connection terminal portion 210 by welding or the like, connection terminal portion 210 is hardly moved in the direction in which connection terminal portion 210 is pressed against connection surface 211 or in an in-plane direction perpendicular to the direction. Therefore, it is not necessary to separately hold connection terminal portion 210 with any jig, and thus, it is possible to smoothly perform the connection work without taking time or effort to install the jig.

Further, opposite surface 212 of connection terminal portion 210 from connection surface 211 is separated from one surface of exterior body 300 from which connection terminal portion 210 is exposed. With this configuration, the heat generated by capacitor element 100 upon energization of capacitor 1 can satisfactorily be released from two surfaces 211 and 212 of connection terminal portion 210.

Further, in capacitor 1, second extension portion 230 extends toward peripheral surface 102 of capacitor element 100 inside exterior body 300, and a part of exterior body 300 is interposed between the distal end of second extension portion 230 and peripheral surface 102.

According to this configuration, the distal end of second extension portion 230 does not come into contact with peripheral surface 102. Thus, peripheral surface 102 of capacitor element 100 can be prevented from being damaged by second extension portion 230.

Further, in capacitor 1, one surface of exterior body 300 positioned apart from connection terminal portion 210 such that opposite surface 212 of the connection terminal portion from connection surface 211 faces the exterior body is casting surface 301.

According to this configuration, even when exterior body 300 is formed by a cast molding method, and connection terminal portion 210 is disposed at the position of casting surface 301 of exterior body 300, liquid-phase thermosetting resin 3 injected into casting mold 2 does not ride on connection surface 211 of connection terminal portion 210 because of a variation in the height of liquid level 3a due to surface tension or a manufacturing error, because connection terminal portion 210 is separated from casting surface 301. This makes it possible to prevent connection failure between connection terminal portion 210 and external terminal 4 caused by thermosetting resin 3 adhering to connection surface 211.

Further, a method of manufacturing capacitor 1 includes an installation step of installing capacitor module 10 including capacitor element 100 including electrode 110 on each of both end surfaces 101 and bus bar 200 connected to electrode 110 in casting mold 2 including opening 2a, an injection step of injecting thermosetting resin 3 in a liquid phase from opening 2a into casting mold 2 in which capacitor module 10 is installed, and a curing step of heating and curing thermosetting resin 3 filled in casting mold 2 to form exterior body 300 covering capacitor element 100 and a part of bus bar 200. Bus bar 200 includes connection terminal portion 210, first extension portion 220, and second extension portion 230. Connection terminal portion 210 includes connection surface 211 having a flat shape to which external terminal 4 is connected. Each of first extension portion 220 and second extension portion 230 extends in a direction (orthogonal direction) intersecting with connection surface 211 toward capacitor element 100 from corresponding one of both ends 210a of connection terminal portion 210 in a first direction. First extension portion 220 is connected to electrode 110. In the installation step, capacitor module 10 is installed in casting mold 2 in a state that connection terminal portion 210 is disposed close to opening 2a. In the injection step, thermosetting resin 3 is injected into casting mold 2 such that liquid level 3a of thermosetting resin 3 to be casting surface 301 of exterior body 300 faces opposite surface 212 of connection terminal portion 210 from connection surface 211 with a distance, and a distal end of first extension portion 220 and a distal end of second extension portion 230 are embedded in thermosetting resin 3.

According to this manufacturing method, it is possible to manufacture capacitor 1 with which connection work of connecting external terminal 4 to connection terminal portion 210 by welding or the like can be smoothly performed.

In addition, it is possible to manufacture capacitor 1 capable of satisfactorily releasing heat generated by capacitor element 100 upon energization of capacitor 1 from connection surface 211 and opposite surface 212 of connection terminal portion 210.

Further, it is possible to manufacture capacitor 1 capable of preventing connection failure between connection terminal portion 210 and external terminal 4 caused by thermosetting resin 3 adhering to connection surface 211.

### <First Modification of First Exemplary Embodiment>

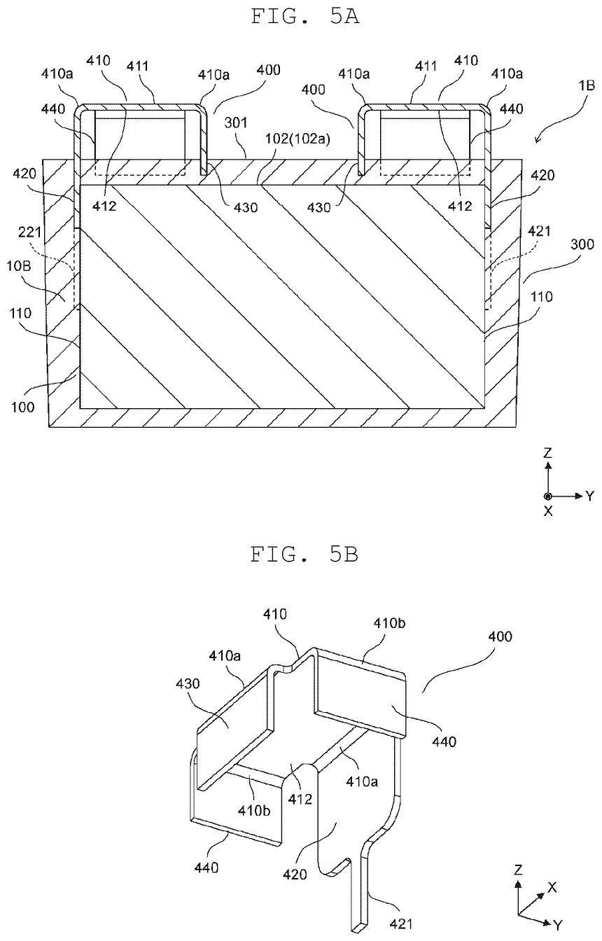

FIG. 4A is a sectional view illustrating capacitor 1A cut in parallel with a Y-Z plane at the positions of a pair of bus bars 200A according to a first modification of the first exemplary embodiment. FIG. 4B is a perspective view illustrating bus bar 200A according to the first modification of the first exemplary embodiment.

Capacitor 1A of the present modification includes a pair of bus bars 200A instead of the pair of bus bars 200 of capacitor 1 of the first exemplary embodiment described above. Capacitor element 100 and the pair of bus bars 200A constitute capacitor module 10A. Other configurations of capacitor 1A are the same as those in capacitor 1 of the first exemplary embodiment.

Each bus bar 200A is bent such that second extension portion 230A approaches first extension portion 220 in the X-axis direction which is the first direction inside exterior body 300. Second extension portion 230A extends such that portion 232 closer to the distal end than bent portion 231 is parallel (including substantially parallel) to peripheral surface 102 (flat surface 102a) of capacitor element 100.

Other configurations of bus bar 200A are the same as those of bus bar 200 of the first exemplary embodiment described above.

According to the configuration of the present modification, even when second extension portion 230 comes into contact with peripheral surface 102 (flat surface 102a) due to the accuracy in forming exterior body 300, the surface facing peripheral surface 102 at portion 232 close to the distal end comes into contact with peripheral surface 102. Thus, peripheral surface 102 is hardly damaged.

Further, even when an external force in the direction in which connection terminal portions 210 are separated from exterior body 300 is applied to connection terminal portions 210 of the pair of bus bars 200, portion 232 close to the distal end becomes a resistance, and second extension portion 230A is hardly removed from the inside of exterior body 300.

### <Second Modification of First Exemplary Embodiment>

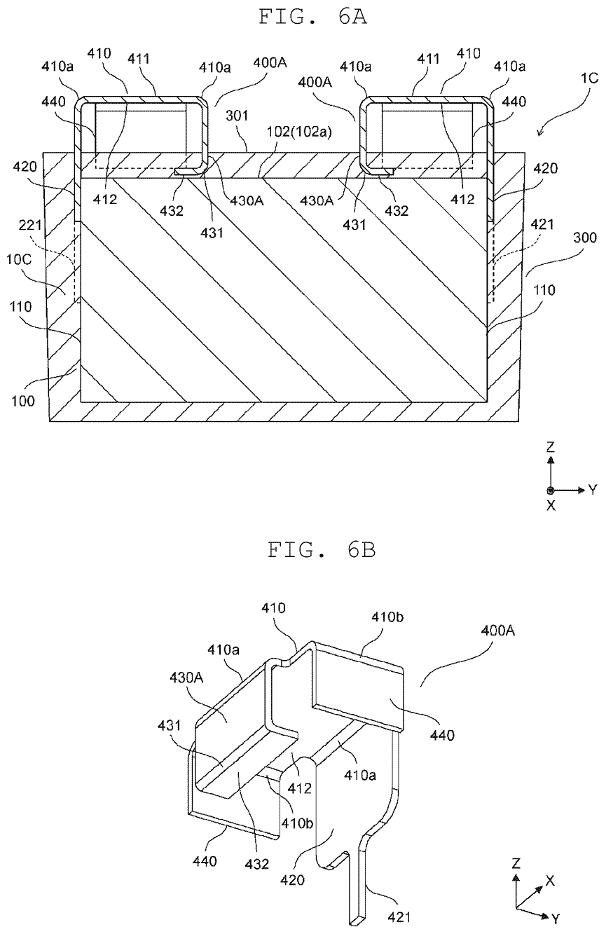

FIG. 5A is a sectional view illustrating capacitor 1B cut in parallel with a Y-Z plane at the positions of a pair of bus bars 400 according to a second modification of the first exemplary embodiment. FIG. 5B is a perspective view illustrating bus bar 400 according to the second modification of the first exemplary embodiment.

Capacitor 1B of the present modification includes a pair of bus bars 400 instead of the pair of bus bars 200 of capacitor 1 according to the first exemplary embodiment described above. Capacitor element 100 and the pair of bus bars 400 constitute capacitor module 10B. Other configurations of capacitor 1B are the same as those in capacitor 1 of the first exemplary embodiment.

Each bus bar 400 is made of a conductive material such as copper, and includes connection terminal portion 410, first extension portion 420, second extension portion 430, and a pair of third extension portions 440.

Connection terminal portion 210 is formed in a substantially rectangular plate shape and has flat connection surface 411 to which external terminal 4 is connected. Connection surface 411 faces the Z-axis positive direction. Connection terminal portion 410 is exposed to the outside from casting surface 301 of exterior body 300. Connection terminal portion 410 is positioned apart from casting surface 301 of exterior body 300 such that opposite surface 412 from connection surface 411 faces casting surface 301.

Each of first extension portion 420 and second extension portion 430 is formed in a rectangular plate shape, and extends in the Z-axis negative direction perpendicular to connection surface 411 from corresponding one of both ends 410a of connection terminal portion 410 in the Y-axis direction.

First extension portion 420 has a longer size in the Z-axis direction than second extension portion 430. Pin-shaped electrode terminal 421 is formed at the distal end of first extension portion 420. The distal end portion of first extension portion 420 is embedded in exterior body 300 from casting surface 301. Electrode terminal 421 of first extension portion 420 is connected to electrode 110 of capacitor element 100 inside exterior body 300.

A distal end portion of second extension portion 430 is embedded in exterior body 300 from casting surface 301 and extends toward peripheral surface 102 (flat surface 102a) of capacitor element 100 inside exterior body 300. The distal end of second extension portion 430 is not in contact with peripheral surface 102, and a portion of exterior body 300 is interposed between the distal end of second extension portion 430 and peripheral surface 102.

Each of the pair of third extension portion 440 is formed in a rectangular plate shape, and extends in the Z-axis negative direction perpendicular to connection surface 411 from corresponding one of both ends 410b of connection terminal portion 410 in the X-axis direction. The X-axis direction is a second direction orthogonal to the first direction.

A distal end portion of each third extension portion 440 is embedded in exterior body 300 from casting surface 301 and extends toward peripheral surface 102 (flat surface 102a) of capacitor element 100 inside exterior body 300. The distal end of third extension portion 440 is not in contact with peripheral surface 102, and a portion of exterior body 300 is interposed between the distal end of third extension portion 440 and peripheral surface 102.

According to the configuration of the present modification, not only both ends 410a of connection terminal portion 410 in the first direction are supported by first extension portion 420 and second extension portion 430 which are embedded in exterior body 300, but also both ends 410b of connection terminal portion 410 in the second direction are supported by the pair of third extension portions 440 which are embedded in exterior body 300. With this configuration, when external terminal 4 is pressed against connection surface 411 of connection terminal portion 410, it is possible to firmly prevent connection terminal portion 410 from moving in the pressed direction or in the in-plane direction perpendicular to the pressed direction.

Third extension portion 440 may be provided only at one end 410a of connection terminal portion 410 in the second direction. In this case as well, as compared with the configuration in which only both ends 410a of connection terminal portion 410 in the first direction are supported by first extension portion 420 and second extension portion 430, the movement of connection terminal portion 410 when external terminal 4 is pressed can be strongly suppressed.

### <Third Modification of First Exemplary Embodiment>

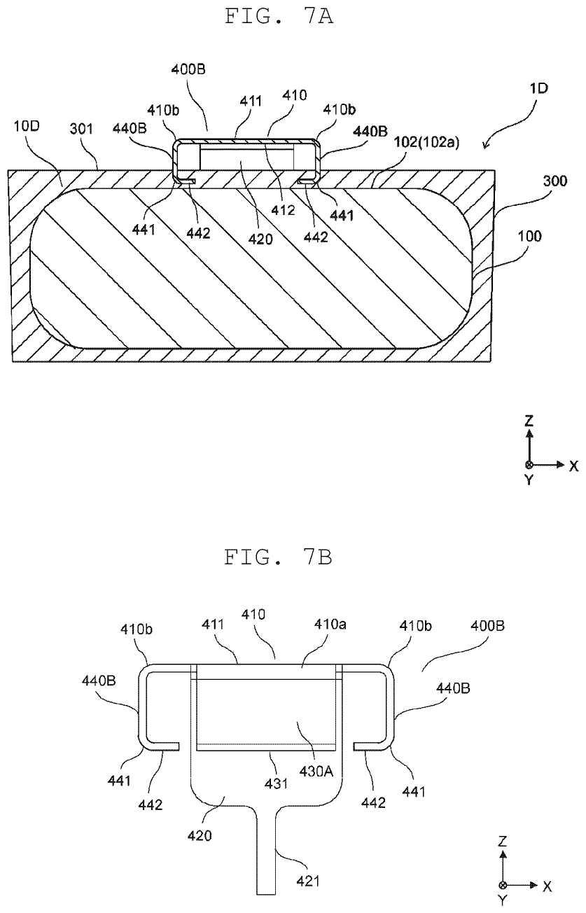

FIG. 6A is a sectional view illustrating capacitor 1C cut in parallel with a Y-Z plane at the positions of a pair of bus bars 400A according to a third modification of the first exemplary embodiment. FIG. 6B is a perspective view illustrating bus bar 400A according to the third modification of the first exemplary embodiment.

Capacitor 1C of the present modification includes a pair of bus bars 400A instead of the pair of bus bars 400 of capacitor 1B of the second modification of the first exemplary embodiment. Capacitor element 100 and the pair of bus bars 400A constitute capacitor module 10C. Other configurations of capacitor 1C are the same as those in capacitor 1B of the second modification of the first exemplary embodiment.

Each bus bar 400A is bent such that second extension portion 430A approaches first extension portion 420 in the X-axis direction which is the first direction inside exterior body 300. Second extension portion 430A extends such that portion 432 closer to the distal end than bent portion 431 is parallel (including substantially parallel) to peripheral surface 102 (flat surface 102a) of capacitor element 100.

Other configurations of bus bar 400A are the same as those of bus bar 400 of the second modification of the first exemplary embodiment described above.

According to the configuration of the present modification, peripheral surface 102 (flat surface 102a) is less likely to be damaged even when second extension portion 430A comes into contact with peripheral surface 102. Further, even when an external force in the direction in which connection terminal portions 410 are separated from exterior body 300 is applied to connection terminal portions 410 of the pair of bus bars 400A, second extension portion 430A is hardly removed from the inside of exterior body 300.

### <Fourth Modification of First Exemplary Embodiment>

FIG. 7A is a sectional view illustrating capacitor 1D cut in parallel with a X-Z plane at the positions of a pair of bus bars 400B according to a fourth modification of the first exemplary embodiment. FIG. 7B is a diagram of bus bar 400B according to the fourth modification of the first exemplary embodiment as viewed in the Y-axis positive direction.

Capacitor 1D of the present modification includes a pair of bus bars 400B instead of the pair of bus bars 400A of capacitor 1C of the third modification of the first exemplary embodiment. Capacitor element 100 and the pair of bus bars 400B constitute capacitor module 10D. Other configurations of capacitor 1D are the same as those in capacitor 1C of the third modification of the first exemplary embodiment.

In each bus bar 400B, a pair of third extension portions 440B is bent so as to approach each other in the X-axis direction which is the second direction inside exterior body 300. Each third extension portion 440B extends such that portion 442 closer to the distal end than bent portion 441 is parallel (including substantially parallel) to peripheral surface 102 (flat surface 102a) of capacitor element 100.

Other configurations of bus bar 400B are the same as those of bus bar 400A of the third modification of the first exemplary embodiment described above.

According to the configuration of the present modification, peripheral surface 102 (flat surface 102a) is less likely to be damaged even when third extension portion 440B comes into contact with peripheral surface 102. Further, even when an external force in the direction in which connection terminal portions 410 are separated from exterior body 300 is applied to connection terminal portions 410 of the pair of bus bars 400B, third extension portion 440B is hardly removed from the inside of exterior body 300.

### <Fifth Modification of First Exemplary Embodiment>

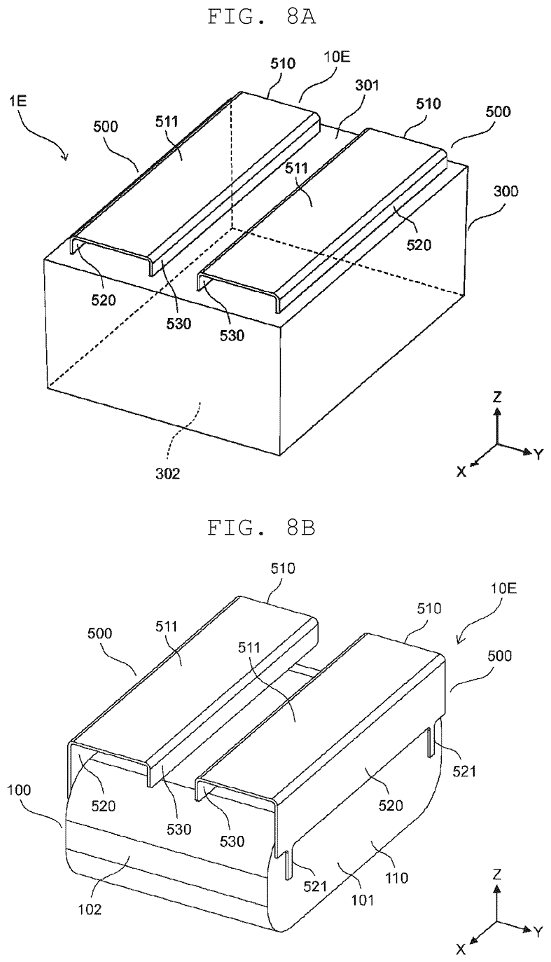

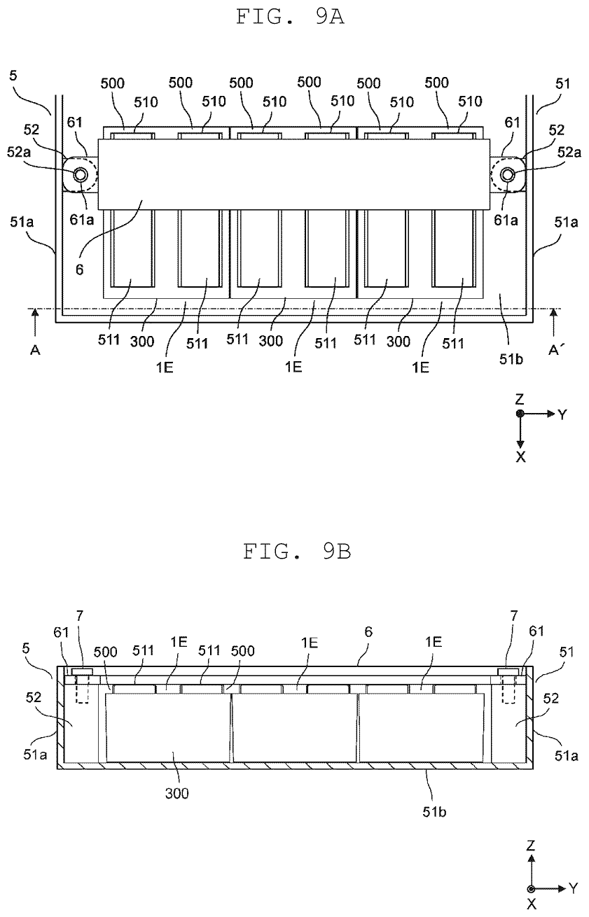

FIG. 8A is a perspective view illustrating capacitor 1E according to a fifth modification of the first exemplary embodiment. FIG. 8B is a perspective view illustrating capacitor module 10E according to the fifth modification of the first exemplary embodiment.

Capacitor 1E of the present modification includes capacitor element 100, a pair of bus bars 500, and exterior body 300. Capacitor element 100 and the pair of bus bars 500 constitute capacitor module 10E.

The pair of bus bars 500 includes connection terminal portion 510 having flat connection surface 511, first extension portion 520 having a pair of electrode terminals 521, and second extension portion 530, and has a configuration having a larger dimension in the X-axis direction (second direction) than the pair of bus bars 200 of the first exemplary embodiment described above. The dimension of each connection terminal portion 510 in the X-axis direction is more than or equal to a half of the dimension of casting surface 301 of exterior body 300 in the X-axis direction, and each connection terminal portion 510 extends to the vicinity of both ends of casting surface 301 in the X-axis direction.

The pair of bus bars 500 is arranged in the Y-axis direction (first direction). In the direction (Z-axis direction) in which capacitor element 100 and connection terminal portion 510 are aligned, positions of connection surfaces 511 of connection terminal portion 510 of bus bars 500 are equal to each other. Each connection surface 511 is parallel (including substantially parallel) to opposite surface 302 (surface at negative direction side in the Z-axis) of exterior body 300 from casting surface 301.

In capacitor 1E of the present modification, each connection terminal portion 510 of the pair of bus bars 500 has a configuration elongated in a direction (second direction) orthogonal to the direction (first direction) in which the pair of bus bars 500 is arranged. Thus, when capacitor 1E is fixed to external device 5 using fixing member 6, a part of flat connection surface 511 of each connection terminal portion 510 can be used as an installation surface on which fixing member 6 is installed.

FIG. 9A is a plan view illustrating a state in which capacitor 1E is fixed to external device 5 using fixing member 6 according to the fifth modification of the first exemplary embodiment, and FIG. 9B is a sectional view taken along line A-A′ of FIG. 9A. In FIG. 9A, illustration of bolt 7 is omitted for convenience.

External device 5 includes, for example, case 51 whose upper surface is open. Case 51 is provided with mounting bosses 52 having bolt holes 52a on both side surface portions 51a in the Y-axis direction.

A predetermined number more than or equal to one, for example, three capacitors 1E are arranged in the direction in which the pair of bus bars 500 is arranged (Y-axis direction) and housed in case 51.

Fixing member 6 has, for example, a rectangular flat plate shape longer in the direction in which the pair of bus bars 500 is arranged (Y-axis direction) than three capacitors 1E arranged in the direction. Mounting tabs 61 having through hole 61a are formed at both ends of fixing member 6.

Fixing member 6 is installed in a partial region of connection surface 511 of each connection terminal portion 510 of three capacitors 1E, for example, in a region at negative direction side in the X-axis. As a result, three capacitors 1E are sandwiched between fixing member 6 and bottom surface portion 51b of case 51. Through holes 61a of two mounting tabs 61 of fixing member 6 are aligned with bolt holes 52a of two mounting bosses 52 of case 51. Bolt 7 that has passed through hole 61a is fixed to bolt hole 52a. Three capacitors 1E are thus fixed to case 51, that is, external device 5.

When fixing member 6 is made of an insulating material, fixing member 6 is directly installed on connection surfaces 511 of connection terminal portions 510. On the other hand, when fixing member 6 is made of a non-insulating (conductive) material, fixing member 6 is disposed on connection surfaces 511 of connection terminal portions 510 via an insulating member such as insulating paper.

In each connection terminal portion 510 of three capacitors 1E, external terminal 4 included in external device 5 is connected to a region of connection surface 511 on which fixing member 6 is not installed.

In capacitor 1E of the present modification, fixing member 6 can be installed on flat connection surface 511 of connection terminal portion 510. Thus, fixing member 6 is less likely to wobble with respect to capacitor 1E. Thus, capacitor 1E can be firmly fixed to external device 5 with fixing member 6.

Unlike capacitor 1E, when a part of connection surface 511 of each connection terminal portion 510 of the pair of bus bars 500 cannot be used as the installation surface on which fixing member 6 is installed, a part of casting surface 301 of exterior body 300 can be used as the installation surface of fixing member 6. However, casting surface 301 is generally less likely to be a flat surface, for example, an edge portion in contact with casting mold 2 is likely to rise because of surface tension. Thus, when fixing member 6 is installed on casting surface 301, fixing member 6 is likely to wobble with respect to the capacitor, and there is a possibility that the capacitor cannot be firmly fixed to external device 5 with fixing member 6.

### <Other Modifications of First Exemplary Embodiment>

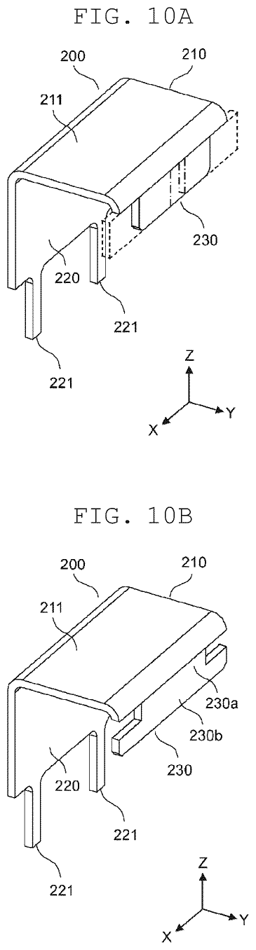

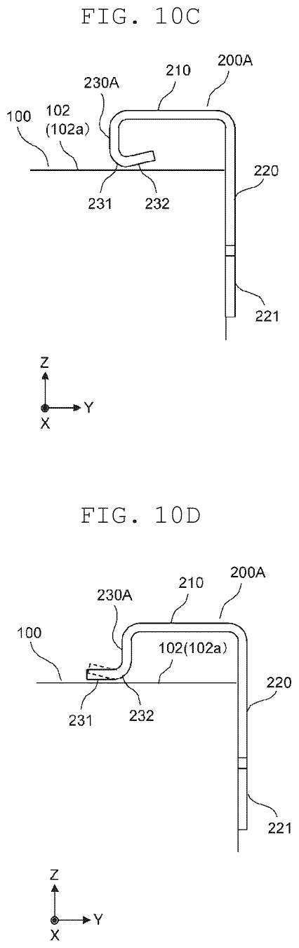

The pair of bus bars 200 of the first exemplary embodiment described above may be changed to have configurations as illustrated in FIGS. 10A and 10B. That is, as illustrated in FIG. 10A, the dimension of second extension portion 230 in the X-axis direction (second direction) may be made smaller than the dimension of connection terminal portion 210 in the same direction. Conversely, as indicated by the broken line in FIG. 10A, the dimension of second extension portion 230 in the X-axis direction may be larger than the dimension of connection terminal portion 210 in the same direction. Further, a gap as indicated by the alternate long and short dashed line in FIG. 10A may be present in the middle of second extension portion 230.

Further, as illustrated in FIG. 10B, second extension portion 230 may include first portion 230a on first extension portion 220 side having a relatively small dimension in the X-axis direction (second direction), and second portion 230b on the opposite side from first extension portion 220 having a relatively large dimension in the X-axis direction. In this configuration, even when an external force in the direction in which connection terminal portion 210 is separated from exterior body 300 is applied to connection terminal portion 210, second portion 230b becomes a resistance, and second extension portion 230 is hardly removed from the inside of exterior body 300.

In the pair of bus bars 400 of the second modification of the first exemplary embodiment described above as well, at least one of second extension portion 430 and third extension portion 440 may be changed to have configurations similar to that in FIGS. 10A and 10B.

Further, the pair of bus bars 200A of the first modification of the first exemplary embodiment described above may be changed to have configurations as illustrated in FIGS. 10C and 10D. That is, as illustrated in FIG. 10C, second extension portion 230A may be configured such that portion 232 closer to the distal end than bent portion 231 extends such that the distance from peripheral surface 102 (flat surface 102a) of capacitor element 100 increases (separates) toward the distal end. Further, as illustrated in FIG. 10D, second extension portion 230A may be bent so as to be away from first extension portion 220 in the X-axis direction (first direction). In this case, as indicated by the broken line in FIG. 10D, portion 232 close to the distal end may extend such that the distance from peripheral surface 102 increases (separates) toward the distal end. Second extension portion 230A illustrated in FIGS. 10C and 10D can also exhibit the same effect as that of the first modification of the first exemplary embodiment.

In the pair of bus bars 400A of the third modification of the first exemplary embodiment described above as well, second extension portion 430A may be changed to have configurations similar to that in FIGS. 10C and 10D. Further, in the pair of bus bars 400B of the fourth modification of the first exemplary embodiment described above as well, at least one of second extension portion 430A and third extension portion 440B may be changed to have configurations similar to that in FIGS. 10C and 10D.

Further, first extension portion 220 of the pair of bus bars 200 of the first exemplary embodiment described above and first extension portion 420 of the pair of bus bars 400 of the second modification of the first exemplary embodiment described above may be formed in the same shape as first extension portion 620 of the pair of bus bars 600 of a second exemplary embodiment described below.

Further, in the first, third, and fourth modifications of the first exemplary embodiment, portions 232, 432, and 442 closer to the distal end than bent portions 231, 431, and 441 of second extension portions 230A and 430A and third extension portion 440B may have shapes that are not linear but slightly warped toward peripheral surface 102 of capacitor element 100.

Any of the configurations of first to fourth modifications of the first exemplary embodiment and the configurations of other modifications of the first exemplary embodiment can be appropriately combined with the configuration of the fifth modification of the first exemplary embodiment.

### Second Exemplary Embodiment

A second exemplary embodiment is an exemplary embodiment of a capacitor according to the second aspect of the present disclosure and a method for manufacturing a capacitor according to the fourth aspect of the present disclosure.

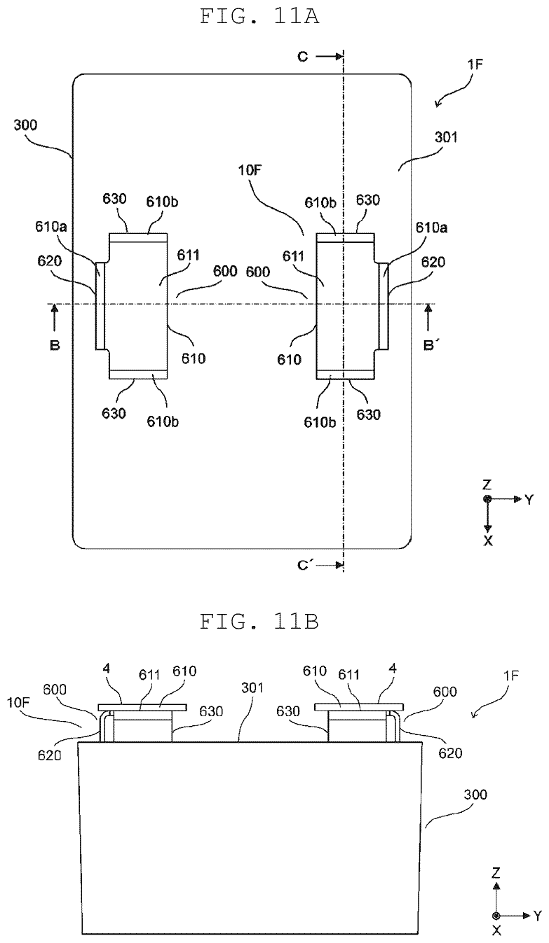

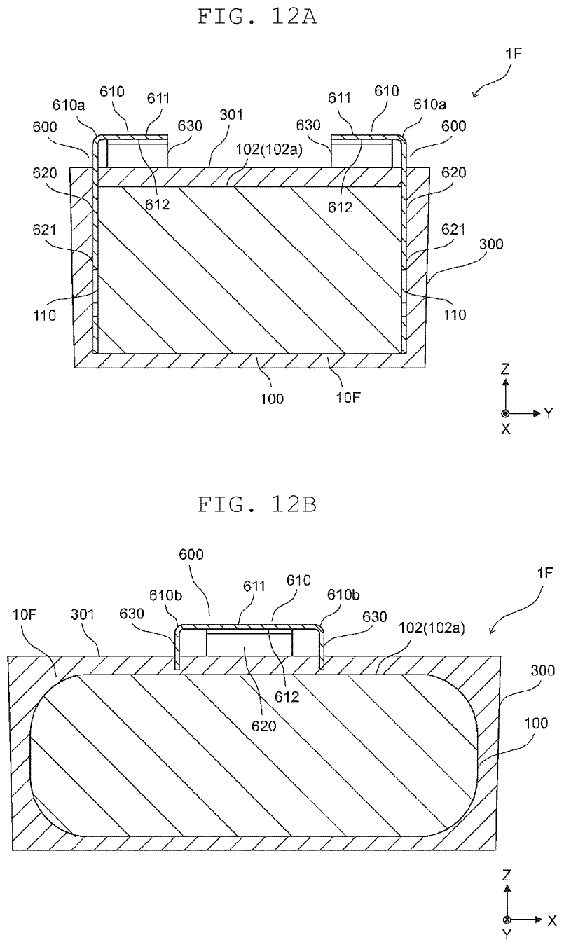

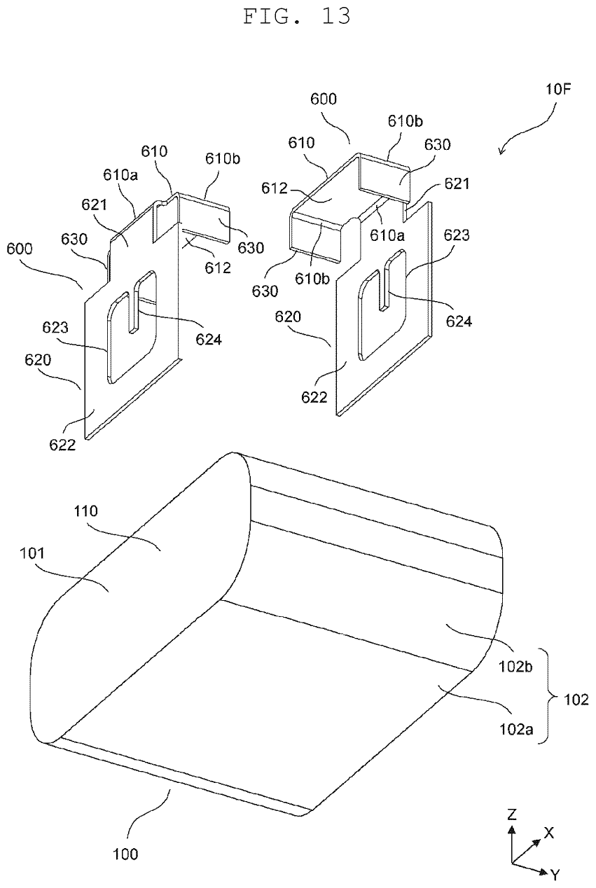

FIG. 11A is a diagram of capacitor 1F according to the second exemplary embodiment as viewed in the Z-axis negative direction, and FIG. 11B is a diagram of capacitor 1F according to the second exemplary embodiment as viewed in the X-axis negative direction. FIGS. 12A and 12B are a B-B′ sectional view and a C-C′ sectional view of FIG. 11A, respectively, according to the second exemplary embodiment. FIG. 13 is an exploded perspective view illustrating capacitor module 10F according to the second exemplary embodiment.

Capacitor 1F includes capacitor element 100, a pair of bus bars 600, and exterior body 300. The pair of bus bars 600 is connected to capacitor element 100 to constitute capacitor module 10F. In capacitor 1F, the configuration of the pair of bus bars 600 is different from the configuration of the pair of bus bars 200 of capacitor 1 of the first exemplary embodiment described above.

The pair of bus bars 600 is made of a conductive material such as copper, and includes connection terminal portion 610, first extension portion 620, and a pair of second extension portions 630.

Connection terminal portion 610 is formed in a substantially rectangular plate shape and has flat connection surface 611 to which external terminal 4 is connected. Connection surface 611 faces the Z-axis positive direction. Connection terminal portion 610 is exposed to the outside from casting surface 301 of exterior body 300. Connection terminal portion 610 is positioned apart from casting surface 301 of exterior body 300 such that opposite surface 612 from connection surface 611 faces casting surface 301.

First extension portion 620 is formed in a rectangular plate shape, and extends from one end 610a of connection terminal portion 610 in the Y-axis direction in the Z-axis negative direction perpendicular to connection surface 611. The Y-axis direction is a first direction. In the present exemplary embodiment, the first direction is perpendicular to end surface 101 of capacitor element 100.

First extension portion 620 includes first portion 621 having a rectangular plate shape and positioned on the side closer to connection terminal portion 610, and second portion 622 having a rectangular plate shape larger than first portion 621 and positioned on the side farther from connection terminal portion 610 than first portion 621. Substantially rectangular opening 623 is formed in second portion 622. Pin-shaped electrode terminal 624 is formed at an end edge of opening 623 at positive direction side in the Z-axis.

A portion of first extension portion 620 close to the distal end (apart of first portion 621 and second portion 622) is embedded in exterior body 300, and electrode terminal 624 is connected to electrode 110 of capacitor element 100 inside exterior body 300.

Each of the pair of second extension portions 630 is formed in a rectangular plate shape, and extends in the Z-axis negative direction perpendicular to connection surface 611 from corresponding one of both ends 610b of connection terminal portion 610 in the X-axis direction. The X-axis direction is a second direction orthogonal to the first direction.

A distal end portion of each second extension portion 630 is embedded in exterior body 300 from casting surface 301 and extends toward peripheral surface 102 (flat surface 102a) of capacitor element 100 inside exterior body 300. The distal end of second extension portion 630 is not in contact with peripheral surface 102, and a portion of exterior body 300 is interposed between the distal end of second extension portion 630 and peripheral surface 102.

In capacitor 1F according to the present exemplary embodiment as well, similarly to capacitor 1 according to the first exemplary embodiment, exterior body 300 is formed by the cast molding method using casting mold 2 described with reference to FIGS. 3A to 3C.

That is, the step of forming exterior body 300 includes an installation step of installing capacitor module 10F in casting mold 2 having opening 2a, an injection step of injecting thermosetting resin 3 in a liquid phase from opening 2a into casting mold 2 in which capacitor module 10F is installed, and a curing step of heating and curing thermosetting resin 3 filled in casting mold 2 to form exterior body 300 covering capacitor module 10F.

In the installation step, capacitor module 10F is installed in casting mold 2 in a state that connection terminal portion 610 is disposed close to opening 2a.

In the injection step, thermosetting resin 3 is injected into casting mold 2 such that liquid level 3a of thermosetting resin 3 to be casting surface 301 of exterior body 300 faces opposite surface 612 of connection terminal portion 610 from connection surface 611 with a distance, and a distal end portion of first extension portion 620 and a distal end of the pair of second extension portion 630 are embedded in thermosetting resin 3.

When capacitor 1F is installed in an external device such as an inverter device and used, one of the pair of bus bars 600 serves as a positive electrode bus bar (P-pole bus bar) and the other serves as a negative electrode bus bar (N-pole bus bar). As illustrated in FIG. 11B, external terminals 4 of the positive electrode (P electrode) and the negative electrode (N electrode) are connected to the connection terminal portions 610 of the pair of bus bars 600 by welding such as laser welding or resistance welding.

### <Effects of Second Exemplary Embodiment>

As described above, the present exemplary embodiment has the following effects.

Capacitor 1F includes capacitor element 100 having electrodes 110 on both end surfaces 101, bus bar 600 connected to electrodes 110, and exterior body 300 formed of thermosetting resin 3 and covering capacitor element 100 and a part of bus bar 600. Bus bar 600 includes connection terminal portion 610, first extension portion 620, and second extension portion 630. Connection terminal portion 610 has flat connection surface 611 to which external terminal 4 is connected, and is exposed from exterior body 300. Opposite surface 612 of connection terminal portion 610 from connection surface 611 is positioned apart from one surface of exterior body 300 in such a manner as to face the one surface. First extension portion 620 extends from end 610a of connection terminal portion 610 in the first direction (Y-axis direction) in a direction intersecting with connection surface 611 (orthogonal direction) and is embedded inside exterior body 300. Second extension portion 630 extends from each of both ends 610b of connection terminal portion 610 in a second direction (X-axis direction) orthogonal to the first direction in a direction (orthogonal direction) intersecting with connection surface 611 and is embedded in exterior body 300. First extension portion 620 is connected to electrode 110 inside exterior body 300.

According to this configuration, both ends 610b of connection terminal portion 610 in the second direction are supported by the pair of second extension portions 630 which are embedded in exterior body 300. Thus, even when external terminal 4 is pressed against connection surface 611 of connection terminal portion 610 at the time of connection work of connecting external terminal 4 to connection terminal portion 610 by welding or the like, connection terminal portion 610 is hardly moved in the direction in which connection terminal portion 610 is pressed against connection surface 611 or in an in-plane direction perpendicular to the direction. Therefore, it is not necessary to separately hold connection terminal portion 610 with any jig, and thus, it is possible to smoothly perform the connection work without taking time or effort to install the jig.

Further, opposite surface 612 of connection terminal portion 610 from connection surface 611 is separated from one surface of exterior body 300 from which connection terminal portion 610 is exposed. With this configuration, the heat generated by capacitor element 100 upon energization of capacitor 1F can satisfactorily be released from two surfaces 611 and 612 of connection terminal portion 610.

Further, in capacitor 1F, second extension portion 630 extends toward peripheral surface 102 of capacitor element 100 inside exterior body 300, and a part of exterior body 300 is interposed between the distal end of second extension portion 630 and peripheral surface 102.

According to this configuration, peripheral surface 102 of capacitor element 100 can be prevented from being damaged by each second extension portion 630.

Further, in capacitor 1F, one surface of exterior body 300 positioned apart from connection terminal portion 610 such that opposite surface 612 from connection surface 611 of the connection terminal portion faces the exterior body is casting surface 301.

According to this configuration, even when exterior body 300 is formed by a cast molding method, and connection terminal portion 610 is disposed at the position of casting surface 301 of exterior body 300, it is possible to prevent a connection failure between connection terminal portion 610 and external terminal 4 caused by thermosetting resin 3 adhering to connection surface 611.

Further, according to the method for manufacturing capacitor 1F, it is possible to manufacture capacitor 1F with which connection work of connecting external terminal 4 to connection terminal portion 610 by welding or the like can be smoothly performed.

In addition, it is possible to manufacture capacitor 1F capable of satisfactorily releasing heat generated by capacitor element 100 upon energization of capacitor 1F from connection surface 611 and opposite surface 612 of connection terminal portion 610.

Further, it is possible to manufacture capacitor 1F capable of preventing connection failure between connection terminal portion 610 and external terminal 4 caused by thermosetting resin 3 adhering to connection surface 611.

### <First Modification of Second Exemplary Embodiment>

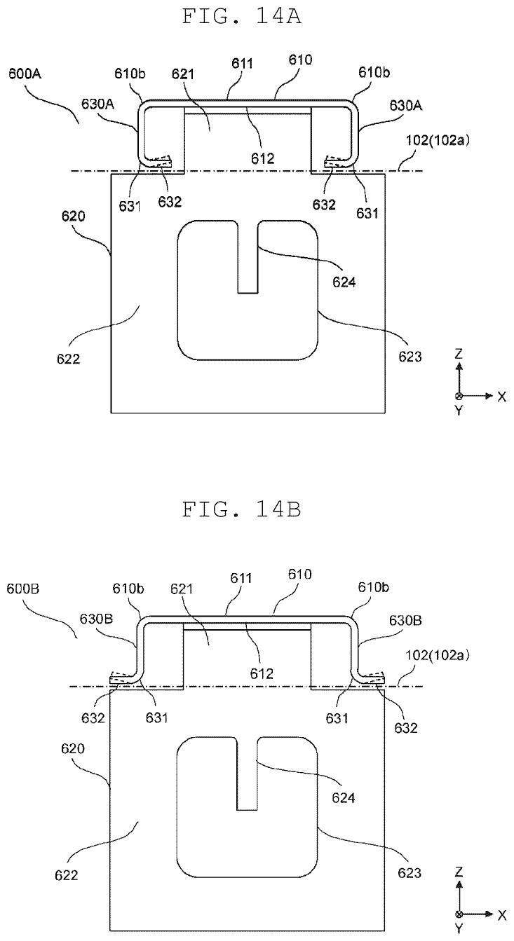

FIG. 14A is a diagram of bus bar 600A according to a first modification of the second exemplary embodiment as viewed in the Y-axis positive direction. In FIG. 14A, for convenience, a part of peripheral surface 102 (flat surface 102a) of capacitor element 100 is drawn by an alternate long and short dashed line.

Capacitor 1F can include a pair of bus bars 600A instead of the pair of bus bars 600.

In each bus bar 600A, a pair of second extension portions 630A is bent so as to approach each other in the X-axis direction which is the second direction inside exterior body 300. Each second extension portion 630A extends such that portion 632 closer to the distal end than bent portion 631 is parallel (including substantially parallel) to peripheral surface 102 of capacitor element 100.

As indicated by the broken line in FIG. 14A, second extension portion 630A may be configured such that portion 632 closer to the distal end than bent portion 631 extends such that the distance from peripheral surface 102 of capacitor element 100 increases (separates) toward the distal end.

Other configurations of bus bar 600A are the same as those of bus bar 600 of the second exemplary embodiment described above.

According to the configuration of the present modification, peripheral surface 102 is less likely to be damaged even when the pair of second extension portions 630A comes into contact with peripheral surface 102. Further, even when an external force in the direction in which connection terminal portions 610 are separated from exterior body 300 is applied to connection terminal portions 610 of the pair of bus bars 600A, pair of second extension portion 630A is hardly removed from the inside of exterior body 300.

### <Second Modification of Second Exemplary Embodiment>

FIG. 14B is a diagram of bus bar 600B according to a second modification of the second exemplary embodiment as viewed in the Y-axis positive direction. In FIG. 14B, for convenience, a part of peripheral surface 102 (flat surface 102a) of capacitor element 100 is drawn by an alternate long and short dashed line.

Capacitor 1F can include a pair of bus bars 600B instead of the pair of bus bars 600.

In each bus bar 600B, a pair of second extension portions 630B is bent so as to be away from each other in the X-axis direction which is the second direction inside exterior body 300. Each second extension portion 630B extends such that portion 632 closer to the distal end than bent portion 631 is parallel (including substantially parallel) to peripheral surface 102 of capacitor element 100.

As indicated by the broken line in FIG. 14B, second extension portion 630B may be configured such that portion 632 closer to the distal end than bent portion 631 extends such that the distance from peripheral surface 102 of capacitor element 100 increases (separates) toward the distal end.

Other configurations of bus bar 600B are the same as those of bus bar 600 of the second exemplary embodiment described above.

According to the configuration of the present modification, the same effects as those of the first modification of the second exemplary embodiment can be exhibited.

### <Third Modification of Second Exemplary Embodiment>

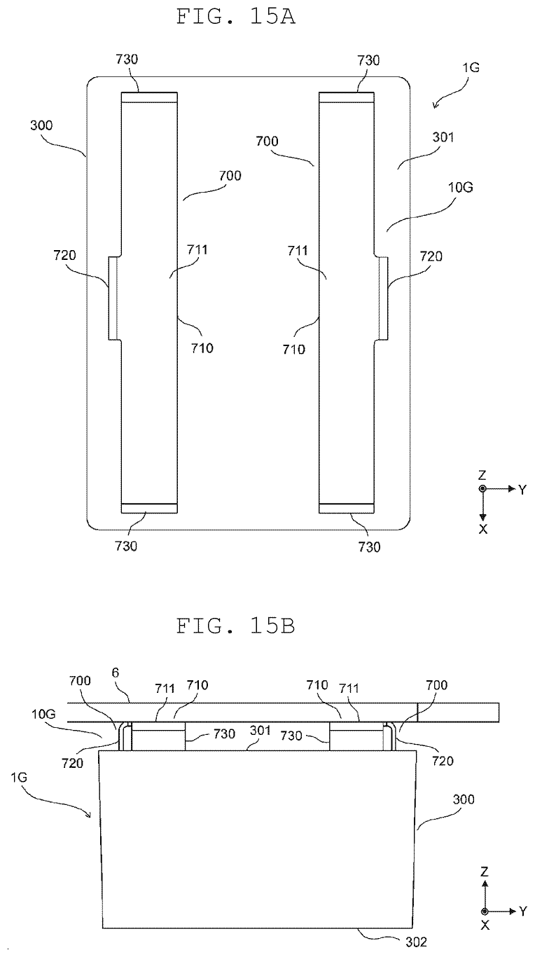

FIG. 15A is a diagram illustrating capacitor 1G according to a third modification of the second exemplary embodiment as viewed in the Z-axis negative direction, and FIG. 15B is a diagram illustrating capacitor 1G according to the second exemplary embodiment as viewed in the X-axis negative direction, in which fixing member 6 is installed.

Capacitor 1G of the present modification includes a pair of bus bars 700. Capacitor element 100 and the pair of bus bars 700 constitute capacitor module 10G.

The pair of bus bars 700 includes connection terminal portion 710 having flat connection surface 711, first extension portion 720, and second extension portion 730, and has a configuration having a larger dimension in the X-axis direction (second direction) than the pair of bus bars 600 of the second exemplary embodiment described above. The dimension of each connection terminal portion 710 in the X-axis direction is more than or equal to a half of the dimension of casting surface 301 of exterior body 300 in the X-axis direction, and each connection terminal portion 710 extends to the vicinity of both ends of casting surface 301 in the X-axis direction.

The pair of bus bars 700 is arranged in the Y-axis direction (first direction). The positions of connection surfaces 711 of connection terminal portions 710 of the pair of bus bars 700 are equal to each other in the direction in which capacitor element 100 and the pair of bus bars 700 are arranged, that is, in the Z-axis direction. Further, two connection surfaces 711 are parallel (including substantially parallel) to opposite surface 302 (surface at negative direction side in the Z-axis) of exterior body 300 from casting surface 301.

In capacitor 1G of the present modification, similarly to capacitor 1E of the fifth modification of the first exemplary embodiment, when capacitor 1G is fixed to external device 5 using fixing member 6, a part of flat connection surface 711 of each connection terminal portion 710 can be used as an installation surface on which fixing member 6 is installed. Thus, capacitor 1G can be firmly fixed to external device 5 with fixing member 6.

### <Other Modifications of Second Exemplary Embodiment>

In the pair of bus bars 600 of the second exemplary embodiment, first extension portion 620 may be formed in the same shape as first extension portion 220 of the pair of bus bars 200 of the first exemplary embodiment or first extension portion 420 of the pair of bus bars 400 of the second modification of the first exemplary embodiment. Further, the pair of second extension portions 630 may be changed to have configurations similar to that in FIGS. 10A and 10B.

### <Other Modifications>

In the first and second exemplary embodiments described above, in exterior body 300, capacitor element 100 takes such an orientation that flat surface 102a of peripheral surface 102 faces casting surface 301 side of exterior body 300. However, in exterior body 300, capacitor element 100 may take such an orientation that curved surface 102b of peripheral surface 102 faces casting surface 301 side of exterior body 300. In this case, for example, in the pair of bus bars 200, second extension portion 230 extends toward curved surface 102b inside exterior body 300. In the pair of bus bars 600, the pair of second extension portions 630 extends toward curved surface 102b inside exterior body 300.

Further, in the first and second exemplary embodiments described above, capacitors 1 and 1F include one capacitor element 100. However, the number of capacitor elements 100 is not limited to one, and may be two or more. In such a case, the capacitor may be configured such that a plurality of capacitor modules are covered with one exterior body. Alternatively, the capacitor may be configured such that one capacitor module configured by connecting a pair of bus bars to a plurality of capacitor elements is covered with an exterior body.

Further, in the first and second exemplary embodiments described above, exterior body 300 is formed by a cast molding method using casting mold 2. However, exterior body 300 may be formed by a molding method using a metal mold. In such a case, casting surface 301 is not present in exterior body 300. Thus, one surface of exterior body 300 where connection terminal portions 210 and 610 of the pair of bus bars 200 and 600 are exposed does not become casting surface 301.

Further, in the first and second exemplary embodiments described above, capacitor element 100 is formed by stacking two metalized films each having vapor-deposited aluminum on a dielectric film, and winding or laminating the stacked metalized films. Alternatively, capacitor element 100 may be formed by stacking an insulating film and a metalized film having vapor-deposited aluminum on both sides of a dielectric film, and winding or laminating the metalized film and the insulating film.

Further, in the first and second exemplary embodiments described above, capacitors 1 and 1F are caseless capacitors. However, the present disclosure is applicable to a case molded capacitor. A case molded capacitor includes a case that houses a capacitor element, and an exterior body is formed in the case by filling the case with a thermosetting resin and curing the thermosetting resin.

Further, in the first and second exemplary embodiments described above, capacitors 1 and 1F are film capacitors. However, capacitors 1 and 1F may be capacitors other than film capacitors.

In addition, the exemplary embodiments of the present disclosure can be modified in various ways as appropriate within the scope of the technical idea disclosed in the appended claims.

### (Supplementary Note)

The above description of the exemplary embodiments discloses the following technologies.

### (Technology 1)

A capacitor including:
a capacitor element including an electrode;
a bus bar connected to the electrode; and
an exterior body covering the capacitor element and a part of the bus bar, the exterior body being made of a resin,
wherein:
the bus bar includes a connection terminal portion, a first extension portion, and a second extension portion,
the connection terminal portion includes a connection surface exposed from the exterior body,
an opposite surface of the connection terminal portion that is opposed to the connection surface is positioned apart from one surface of the exterior body, the opposite surface facing the one surface,
each of the first extension portion and the second extension portion extends from corresponding one of both ends in a first direction of the connection terminal portion, a part of the each of the first extension portion and the second extension portion extending in a direction intersecting with the connection surface and being embedded in the exterior body, and
the first extension portion is connected to the electrode inside the exterior body.

According to this technology, at the time of connection work of connecting the external terminal to the connection terminal portion by welding or the like, it is not necessary to separately hold the connection terminal portion with any jig. Thus, it is possible to smoothly perform the connection work without taking time or effort to install the jig.

Further, the heat generated by the capacitor element upon energization of the capacitor can satisfactorily be released from two surfaces of the connection terminal portion.

### (Technology 2)

The capacitor according to Technology 1, wherein
the second extension portion extends toward a peripheral surface of the capacitor element inside the exterior body, and
a part of the exterior body is disposed between a distal end of the second extension portion and the peripheral surface.

According to this technology, the peripheral surface of the capacitor element can be prevented from being damaged by the second extension portion.

### (Technology 3)

The capacitor according to Technology 2, wherein:
the second extension portion is bent in the first direction at a bent portion of the second extension portion inside the exterior body, and
a part of the second extension portion closer to the distal end than the bent portion extends in parallel to the peripheral surface or extends to incline with respect to the peripheral surface so that a distance between the part of the second extension portion and the peripheral surface increases toward the distal end.

According to this technology, the peripheral surface is less likely to be damaged even when the second extension portion comes into contact with the peripheral surface.

### (Technology 4)

The capacitor according to any one of Technologies 1 to 3, wherein
the bus bar further includes a third extension portion, and
the third extension portion extends from an end of the connection terminal portion in a second direction orthogonal to the first direction, a part of the third extension portion extending in a direction intersecting with the connection surface and being embedded in the exterior body.

According to this technology, when the external terminal is pressed against the connection surface of the connection terminal portion, it is possible to firmly prevent the connection terminal portion from moving in the pressed direction or in an in-plane direction perpendicular to the pressed direction.

### (Technology 5)

The capacitor according to Technology 4, wherein:
the third extension portion is bent in the second direction at a bent portion of the third extension portion inside the exterior body, and
a part of the third extension portion closer to a distal end of the third extension portion than the bent portion extends in parallel to a peripheral surface of the capacitor element or extends to incline with respect to the peripheral surface so that a distance between the part of the third extension portion and the peripheral surface increases toward the distal end.

According to this technology, the peripheral surface is less likely to be damaged even when the third extension portion comes into contact with the peripheral surface.

### (Technology 6)

A capacitor including:
a capacitor element including an electrode on each of both end surfaces of the capacitor element;
a bus bar connected to the electrode; and
an exterior body covering the capacitor element and a part of the bus bar, the exterior body being made of a resin,
wherein:
the bus bar includes a connection terminal portion, a first extension portion, and a second extension portion,
the connection terminal portion includes a connection surface having a flat shape, the connection terminal portion being exposed from the exterior body,
an opposite surface of the connection terminal portion that is opposed to the connection surface is positioned apart from one surface of the exterior body, the opposite surface facing the one surface,
the first extension portion extends from an end in a first direction of the connection terminal portion, a part of the first extension portion extending in a direction intersecting with the connection surface and being embedded in the exterior body,
the second extension portion extends from each of both ends in a second direction orthogonal to the first direction of the connection terminal portion, a part of the second extension portion extending in the direction intersecting with the connection surface and being embedded in the exterior body, and
the first extension portion is connected to the electrode inside the exterior body.

According to this technology, at the time of connection work of connecting the external terminal to the connection terminal portion by welding or the like, it is not necessary to separately hold the connection terminal portion with any jig. Thus, it is possible to smoothly perform the connection work without taking time or effort to install the jig.

Further, the heat generated by the capacitor element upon energization of the capacitor can satisfactorily be released from two surfaces of the connection terminal portion.

### (Technology 7)

The capacitor according to Technology 6, wherein
the second extension portion extends toward a peripheral surface of the capacitor element inside the exterior body, and
a part of the exterior body is disposed between a distal end of the second extension portion and the peripheral surface.

According to this technology, the peripheral surface of the capacitor element can be prevented from being damaged by the second extension portion.

### (Technology 8)

The capacitor according to Technology 7, wherein:
the second extension portion is bent in the second direction at a bent portion of the second extension portion inside the exterior body, and
a part of the second extension portion closer to the distal end than the bent portion extends in parallel to the peripheral surface or extends to incline with respect to the peripheral surface so that a distance between the part of the second extension portion and the peripheral surface increases toward the distal end.

According to this technology, the peripheral surface is less likely to be damaged even when each second extension portion comes into contact with the peripheral surface.

### (Technology 9)

The capacitor according to any one of Technologies 1 to 8,
wherein the one surface of the exterior body is a casting surface.

According to this technology, even when the exterior body is formed by a cast molding method, and the connection terminal portion is disposed at the position of the casting surface of the exterior body, it is possible to prevent a connection failure between the connection terminal portion and the external terminal caused by the thermosetting resin adhering to the connection surface.

### (Technology 10)

The capacitor according to Technology 9, wherein
the bus bar is arranged in the first direction, and
a dimension of the connection terminal portion in a second direction orthogonal to the first direction is more than or equal to a half of a dimension of the casting surface in the second direction.

According to this technology, when the capacitor is fixed to an external device using the fixing member, a part of the flat connection surface of each connection terminal portion can be used as an installation surface on which the fixing member is installed.

### (Technology 11)

A method for manufacturing a capacitor, the method including:
an installation step of installing a capacitor module in a casting mold including an opening, the capacitor module including a capacitor element including an electrode on each of both end surfaces of the capacitor element and a bus bar connected to the electrode;
an injection step of injecting a thermosetting resin in a liquid phase from the opening into the casting mold in which the capacitor module is installed; and
a curing step of heating and curing the thermosetting resin filled in the casting mold to form an exterior body covering the capacitor element and a part of the bus bar,
wherein:
the bus bar includes a connection terminal portion, a first extension portion, and a second extension portion,
the connection terminal portion includes a connection surface having a flat shape to which an external terminal is connected,
each of the first extension portion and the second extension portion extends from corresponding one of both ends in a first direction of the connection terminal portion, the each of the first extension portion and the second extension portion extending in a direction intersecting with the connection surface toward the capacitor element,
the first extension portion is connected to the electrode,
in the installation step, the capacitor module is installed in the casting mold in a state that the connection terminal portion is disposed close to the opening, and
in the injection step, the thermosetting resin is injected into the casting mold so that a liquid level of the thermosetting resin to be a casting surface of the exterior body faces an opposite surface of the connection terminal portion that is opposed to the connection surface with being apart from the opposite surface, and a distal end of the first extension portion and a distal end of the second extension portion are embedded in the thermosetting resin.

### (Technology 12)

A method for manufacturing a capacitor, the method including:
an installation step of installing a capacitor module in a casting mold including an opening, the capacitor module including a capacitor element including an electrode on each of both end surfaces of the capacitor element and a bus bar connected to the electrode;
an injection step of injecting a thermosetting resin in a liquid phase from the opening into the casting mold in which the capacitor module is installed; and
a curing step of heating and curing the thermosetting resin filled in the casting mold to form an exterior body covering the capacitor element and a part of the bus bar,
wherein:
the bus bar includes a connection terminal portion, a first extension portion, and a second extension portion,
the connection terminal portion includes a connection surface having a flat shape to which an external terminal is connected,
the first extension portion extends from an end in a first direction of the connection terminal portion toward the capacitor element in a direction intersecting with the connection surface, the first extension portion being connected to the electrode,
the second extension portion extends from each of both ends in a second direction orthogonal to the first direction of the connection terminal portion toward the capacitor element in a direction intersecting with the connection surface,
in the installation step, the capacitor module is installed in the casting mold in a state that the connection terminal portion is disposed close to the opening, and
in the injection step, the thermosetting resin is injected into the casting mold so that a liquid level of the thermosetting resin to be a casting surface of the exterior body faces an opposite surface of the connection terminal portion that is opposed to the connection surface with being apart from the opposite surface, and a distal end of the first extension portion and a distal end of the second extension portion are embedded in the thermosetting resin.

According to these technologies 11 and 12, it is possible to manufacture a capacitor with which connection work of connecting the external terminal to the connection terminal portion by welding or the like can be smoothly performed.

In addition, it is possible to manufacture a capacitor capable of satisfactorily releasing heat generated by the capacitor element upon energization of the capacitor from two surfaces of the connection terminal portion.

Further, it is possible to manufacture a capacitor capable of preventing connection failure between the connection terminal portion and the external terminal caused by the thermosetting resin adhering to the connection surface.

The present disclosure is useful for capacitors used for various electronic devices, electric devices, industrial devices, electric components of vehicles, and the like.

What is claimed is:

1. A capacitor comprising:
a capacitor element including an electrode;
a bus bar connected to the electrode; and
an exterior body covering the capacitor element and a part of the bus bar, the exterior body being made of a resin,
wherein:
the bus bar includes a connection terminal portion, a first extension portion, and a second extension portion,
the connection terminal portion includes a connection surface exposed from the exterior body,
an opposite surface of the connection terminal portion that is opposed to the connection surface is positioned apart from one surface of the exterior body, the opposite surface facing the one surface,
each of the first extension portion and the second extension portion extends from corresponding one of both ends in a first direction of the connection terminal portion, a part of the each of the first extension portion and the second extension portion extending in a direction intersecting with the connection surface and being embedded in the exterior body, and
the first extension portion is connected to the electrode inside the exterior body.

2. The capacitor according to claim 1, wherein:
the second extension portion extends toward a peripheral surface of the capacitor element inside the exterior body, and
a part of the exterior body is disposed between a distal end of the second extension portion and the peripheral surface.

3. The capacitor according to claim 2, wherein:
the second extension portion is bent in the first direction at a bent portion of the second extension portion inside the exterior body, and
a part of the second extension portion closer to the distal end than the bent portion extends in parallel to the peripheral surface or extends to incline with respect to the peripheral surface so that a distance between the part of the second extension portion and the peripheral surface increases toward the distal end.

4. The capacitor according to claim 1, wherein:
the bus bar further includes a third extension portion, and
the third extension portion extends from an end of the connection terminal portion in a second direction orthogonal to the first direction, a part of the third extension portion extending in a direction intersecting with the connection surface and being embedded in the exterior body.

5. The capacitor according to claim 4, wherein:
the third extension portion is bent in the second direction at a bent portion of the third extension portion inside the exterior body, and
a part of the third extension portion closer to a distal end of the third extension portion than the bent portion extends in parallel to a peripheral surface of the capacitor element or extends to incline with respect to the peripheral surface so that a distance between the part of the third extension portion and the peripheral surface increases toward the distal end.

6. A capacitor comprising:
a capacitor element including an electrode on each of both end surfaces of the capacitor element;
a bus bar connected to the electrode; and
an exterior body covering the capacitor element and a part of the bus bar, the exterior body being made of a resin,
wherein:
the bus bar includes a connection terminal portion, a first extension portion, and a second extension portion,
the connection terminal portion includes a connection surface having a flat shape, the connection terminal portion being exposed from the exterior body,
an opposite surface of the connection terminal portion that is opposed to the connection surface is positioned apart from one surface of the exterior body, the opposite surface facing the one surface,
the first extension portion extends from an end in a first direction of the connection terminal portion, a part of the first extension portion extending in a direction intersecting with the connection surface and being embedded in the exterior body,
the second extension portion extends from each of both ends in a second direction orthogonal to the first direction of the connection terminal portion, a part of the second extension portion extending in the direction intersecting with the connection surface and being embedded in the exterior body, and
the first extension portion is connected to the electrode inside the exterior body.

7. The capacitor according to claim 6, wherein:
the second extension portion extends toward a peripheral surface of the capacitor element inside the exterior body, and
a part of the exterior body is disposed between a distal end of the second extension portion and the peripheral surface.

8. The capacitor according to claim 7, wherein:
the second extension portion is bent in the second direction at a bent portion of the second extension portion inside the exterior body, and
a part of the second extension portion closer to the distal end than the bent portion extends in parallel to the peripheral surface or extends to incline with respect to the peripheral surface so that a distance between the part of the second extension portion and the peripheral surface increases toward the distal end.

9. The capacitor according to claim 1,
wherein the one surface of the exterior body is a casting surface.

10. The capacitor according to claim 9, wherein:
the bus bar is arranged in the first direction, and
a dimension of the connection terminal portion in a second direction orthogonal to the first direction is more than or equal to a half of a dimension of the casting surface in the second direction.

11. The capacitor according to claim 6,
wherein the one surface of the exterior body is a casting surface.

12. The capacitor according to claim 11, wherein:
the bus bar is arranged in the first direction, and
a dimension of the connection terminal portion in a second direction orthogonal to the first direction is more than or equal to a half of a dimension of the casting surface in the second direction.

13. The capacitor according to claim 1, wherein:
a dimension of the second extension portion in a second direction orthogonal to the first direction is less than a dimension of the connection terminal portion in the second direction.

14. The capacitor according to claim 1, wherein:
a dimension of the second extension portion in a second direction orthogonal to the first direction is more than a dimension of the connection terminal portion in the second direction.

15. The capacitor according to claim 1, wherein:
the second extension portion includes a first part disposed between the connection terminal portion and a distal end of the second extension portion, a dimension of the first part in a second direction orthogonal to the first direction being less than a dimension of the connection terminal portion in the second direction.

16. The capacitor according to claim 6, wherein:
a dimension of the second extension portion in the first direction is less than a dimension of the connection terminal portion in the first direction.

17. The capacitor according to claim 6, wherein:
a dimension of the second extension portion in the first direction is more than a dimension of the connection terminal portion in the first direction.

18. The capacitor according to claim 6, wherein:
the second extension portion includes a first part disposed between the connection terminal portion and a distal end of the second extension portion, a dimension of the first part in the first direction being less than a dimension of the connection terminal portion in the first direction.

19. A method for manufacturing a capacitor, the method comprising:
an installation step of installing a capacitor module in a casting mold including an opening, the capacitor module including a capacitor element including an electrode on each of both end surfaces of the capacitor element and a bus bar connected to the electrode;
an injection step of injecting a thermosetting resin in a liquid phase from the opening into the casting mold in which the capacitor module is installed; and
a curing step of heating and curing the thermosetting resin filled in the casting mold to form an exterior body covering the capacitor element and a part of the bus bar,
wherein:
the bus bar includes a connection terminal portion, a first extension portion, and a second extension portion,
the connection terminal portion includes a connection surface having a flat shape to which an external terminal is connected,
each of the first extension portion and the second extension portion extends from corresponding one of both ends in a first direction of the connection terminal portion, the each of the first extension portion and the second extension portion extending in a direction intersecting with the connection surface toward the capacitor element,
the first extension portion is connected to the electrode,
in the installation step, the capacitor module is installed in the casting mold in a state that the connection terminal portion is disposed close to the opening, and
in the injection step, the thermosetting resin is injected into the casting mold so that a liquid level of the thermosetting resin to be a casting surface of the exterior body faces an opposite surface of the connection terminal portion that is opposed to the connection surface with being apart from the opposite surface, and a distal end of the first extension portion and a distal end of the second extension portion are embedded in the thermosetting resin.

20. A method for manufacturing a capacitor, the method comprising:
an installation step of installing a capacitor module in a casting mold including an opening, the capacitor module including a capacitor element including an electrode on each of both end surfaces of the capacitor element and a bus bar connected to the electrode;
an injection step of injecting a thermosetting resin in a liquid phase from the opening into the casting mold in which the capacitor module is installed; and
a curing step of heating and curing the thermosetting resin filled in the casting mold to form an exterior body covering the capacitor element and a part of the bus bar,
wherein:
the bus bar includes a connection terminal portion, a first extension portion, and a second extension portion,
the connection terminal portion includes a connection surface having a flat shape to which an external terminal is connected,
the first extension portion extends from an end in a first direction of the connection terminal portion toward the capacitor element in a direction intersecting with the connection surface, the first extension portion being connected to the electrode,
the second extension portion extends from each of both ends in a second direction orthogonal to the first direction of the connection terminal portion toward the capacitor element in a direction intersecting with the connection surface,
in the installation step, the capacitor module is installed in the casting mold in a state that the connection terminal portion is disposed close to the opening, and
in the injection step, the thermosetting resin is injected into the casting mold so that a liquid level of the thermosetting resin to be a casting surface of the exterior body faces an opposite surface of the connection terminal portion that is opposed to the connection surface with being apart from the opposite surface, and a distal end of the first extension portion and a distal end of the second extension portion are embedded in the thermosetting resin.
